(19) United States
(12) Patent Application Publication
(10) Pub. No.: US 2019/0005799 A1
(43) Pub. Date: Jan. 3, 2019

(54) Preprogrammed electronic reminder device

(71) Applicant: Michael James Elkington, Scarborough (AU)

(72) Inventor: Michael James Elkington, Scarborough (AU)

(21) Appl. No.: 15/638,398

(22) Filed: Jun. 30, 2017

(51) Int. Cl. G08B 21/24; G08B 5/36

(52) U.S. Cl. CPC G08B 21/24; G04B 19/24; G08B 5/36

(57) ABSTRACT

A preprogrammed electronic reminding device is provided with color coded light indicators that correspond to a color associated with a particular task. The device comprises of a housing, PCB and preprogrammed micro-controller. The face of device is customizable for the display of information in the way of but not limited to logos, advertising or other messages. The reminder device has a means for fastening the housing to another surface.

### REFERENCE TO RELATED APPLICATIONS

The present application relates and claims priority to Australian provisional patent application No. 2016902607, filed on 2016 Jul. 2.

### FIELD OF THE INVENTION

The invention relates generally to an electronic reminder device, more particularly it relates to a preprogrammed electronic reminder with color coded light indicators corresponding to the color of refuse bins due for collection in a particular period of time.

### BACKGROUND OF THE INVENTION

The use of electronic reminders for short term household tasks from simply boiling an egg to operating a domestic oven with a built-in timer is commonplace. Such electronic reminders work in short term cycles, typically minutes to hours and act essentially as electronic timers.

Households tasks or events with longer cycle times such as appointments, lawn mowing or building maintenance are typically done on an as-remembered basis, which is acceptable to the home occupier as no fixed time-line exists for these to be completed. However certain household tasks with longer cycle time must be completed at specific times otherwise the window for completing the task is lost until the next cycle. A specific example of such a task is household bin or refuse container collection.

Household bin or refuse container collection typically operates on a weekly cycle requiring the home occupier to position one or more specific colored bins, on a specific day of the week, for collection by the local municipal refuse collection vehicle. Usually the local municipal authority issues a color coded refuse collection calendar detailing which colored household bins are due for collection in a specific week.

### SUMMARY OF THE INVENTION

### Technical Problem

The busy home occupier with multiple tasks to perform during a week may naturally forget relatively mundane task such placing the correct color bin or bins out side their property for collection either the evening before or on the morning the local municipal refuse collection vehicle arrives. Documents such as the color coded refuse collection calendar are often misplaced by the home occupier, leading them to rely on checking the color bin or bins placed by neighbours outside their respective properties. This reliance on others can lead to incorrect colored bin selection, resulting in undesirable accumulation of waste until the next time a specific colored bin is collected.

### Solution to Problem

This invention is directed to an electronic reminder device that alerts the user to a specific event by visual alert signals. More specifically the electronic reminder prompts the user to complete an activity or task associated with a specific color by the flashing of an LED light of the same or similar color present on the surface of the device.

### Advantageous Effects of Invention

The electronic device includes housing, power source, printed circuitry, one or more color LED lights corresponding to the colors associated with a specific activity or task and control buttons on the front face of the device.

The electronic device includes a preprogrammed MCU, which is programmed to coincide with the local area, specific activity or task.

In other embodiments the device further includes one or more of the following features: blue-tooth connectivity, motion sensor for battery/power conservation, LCD display, thermometer and solar panel.

In other embodiments the device further includes one or more fastening means on the rear face of the device and/or use of internal magnets.

In other embodiments the device has a rear housing, a stick on front fascia which incorporates any color of lens for the visual light alert needed.

### BRIEF DESCRIPTION OF THE DRAWINGS

The accompanying drawing(s), which are incorporated in and constitute a part of this specification, illustrate several aspects described below.

FIG. 01 is a front view of one embodiment of an electronic reminder consistent with the present invention.

FIG. 02 is a side view of one embodiment of an electronic reminder consistent with the present invention.

FIG. 03 is a front view of another embodiment of an electronic reminder consistent with the present invention.

FIG. 04 is a front view of another embodiment of an electronic reminder consistent with the present invention.

FIG. 05 is a schematic of the internal electrical components of an electronic reminder consistent with the present invention.

FIG. 06 is a schematic of another embodiment of the internal electrical components of an electronic reminder consistent with the present invention.

### DESCRIPTION OF THE EMBODIMENTS

It is to be understood that this invention is not limited to particular embodiments described, as such may, of course, vary. It is also to be understood that the terminology used herein is for the purpose of describing particular embodiments only, and is not intended to be limiting, since the scope of this invention will be limited only by the appended claims.

The detailed description of the invention is divided into various sections only for the reader's convenience and disclosure found in any section may be combined with that in another section. Unless defined otherwise, all technical and scientific terms used herein have the same meaning as commonly understood by one of ordinary skill in the art to which this invention belongs.

It must be noted that as used herein and in the appended claims, the singular forms “a”, “an”, and “the” include plural referents unless the context dearly dictates otherwise

### 1. Definitions

Unless defined otherwise, all technical terms used herein have the same meaning as commonly understood by one of ordinary skill in the art to which this invention belongs. As used herein the following terms have the following meanings.

In the present specification and claims (if any), the word “comprising” and its derivatives including “comprises” and “comprise” include each of the stated integers but does not exclude the inclusion of one or more further integers.

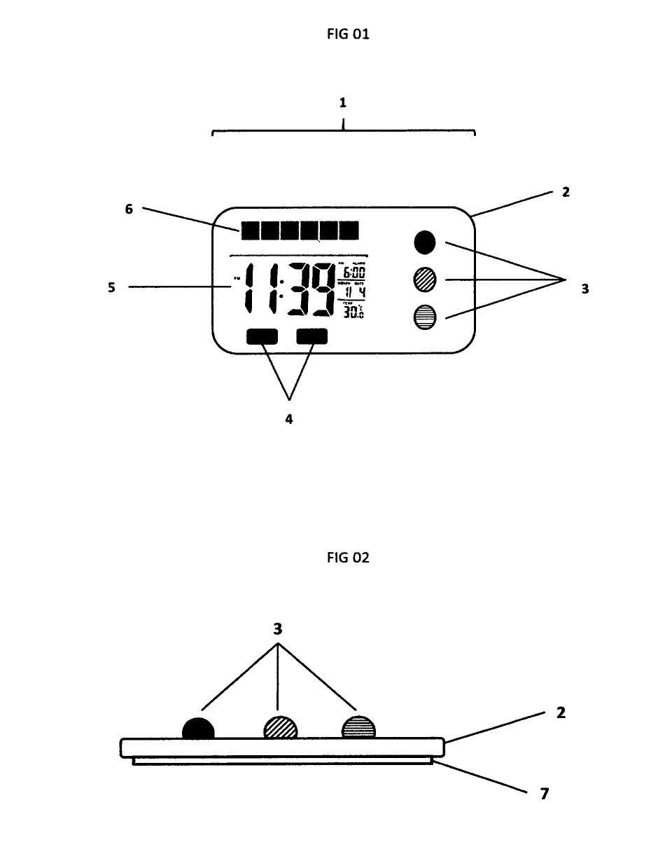

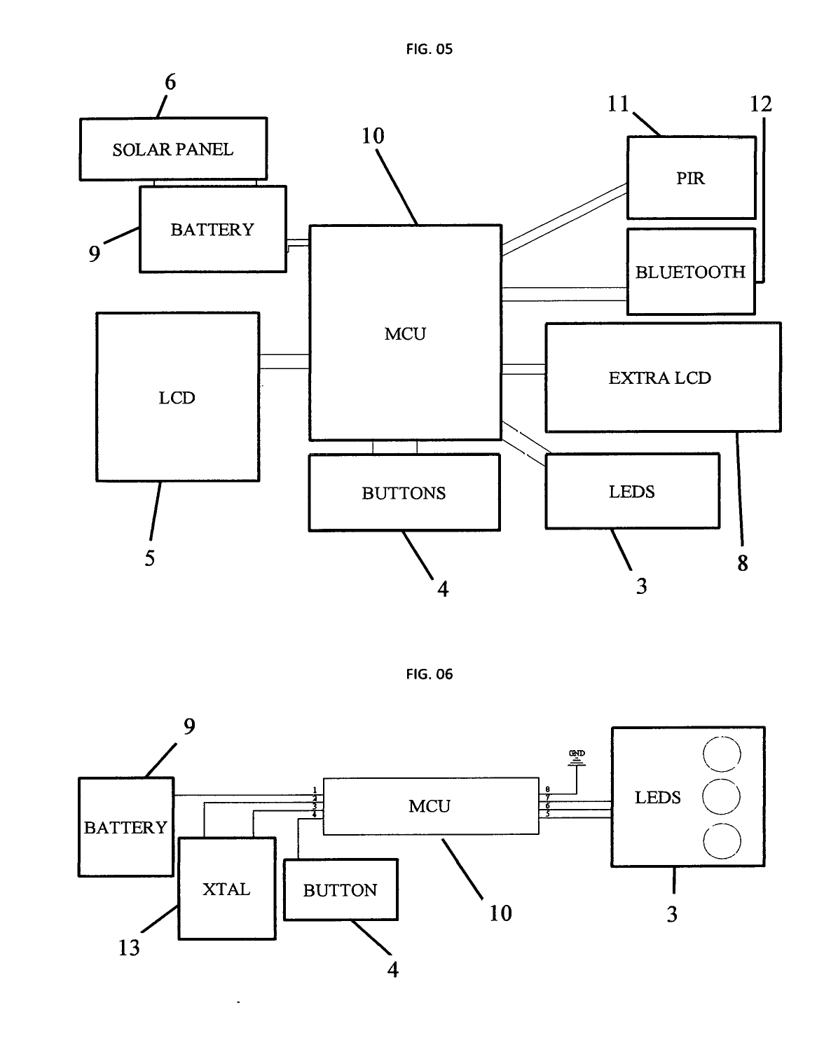

Detailed discussion of the figures: where numbers 9-14 are mentioned but not shown in FIGS. 1-4, they are internal components and therefore shown in FIG. 5-6

With reference to FIG. 01 illustrates an exemplary embodiment of the electronic reminder device 1 comprising a housing 2 containing micro controller unit 10, printed circuitry board, back-up battery 9 and optionally bluetooth communication device 12, motion sensor 11 and thermometer. It is contemplated that the housing 2 is constructed from plastic or recycled material and may be of any shape or dimension. In the preferred embodiment the housing is a square or rectangular box.

In the exemplary configuration of the front face of the device 1 as shown in FIG. 01, three differentially colored light emitting diode (LED) lights 3 are aligned vertically. It is understood that one or more such LED lights may be used in the electronic reminder device of the present invention and may be located anywhere on the device, though its preferred they are positioned within easy view of the user on the front face of the device. Any combination of colors may be used, dearly the choice of color will be directed by the corresponding colors associated with the tasks.

For example if the user has three refuse bins: a green, brown and blue bin then the LED lights on the device will be green, brown and blue.

In the exemplary configuration of the front face of the device 1 as shown in FIG. 01, a liquid crystal display (LCD) screen 5 is positioned in a covered portion of the front face. The LCD display screen may provide the user with one or more selected from the following parameters: date, day, temperature, time and other relevant information. The date, day and time display is controlled via the use of control buttons 4. It is contemplated that one or more of such control buttons 4 are provided to select the parameters.

In the exemplary configuration of the front face of the device 1 as shown in FIG. 01, a solar panel 6 is positioned on the front face in such a suitable location to be exposed to available light in the users home or property. This in combination with a back up battery 9 held within the housing provides power to the device.

It is further contemplated that a motion sensor 11 is located within the housing 2 which provides a power saving mode wherein the reminder device 1 remains in a dormant power saving mode until motion is detected, for example by movement of an appliance or internal home door to which the reminder device 1 is attached.

With reference to an exemplary profile view shown of the reminder device 1, FIG. 02 illustrates housing 2 with a magnetic strip 7 attached to the rear face and three LED lights 3 protruding from the front face. The magnetic strip 7, affixed to the housing 2 using a suitable adhesive, enables the reminder device to be attached to a metallic device. Attachment by other means such as adhesive strips, button magnet, internal magnet, suction cups, Velcro or other suitable method known in the art may be substituted depending on the desired position of attachment.

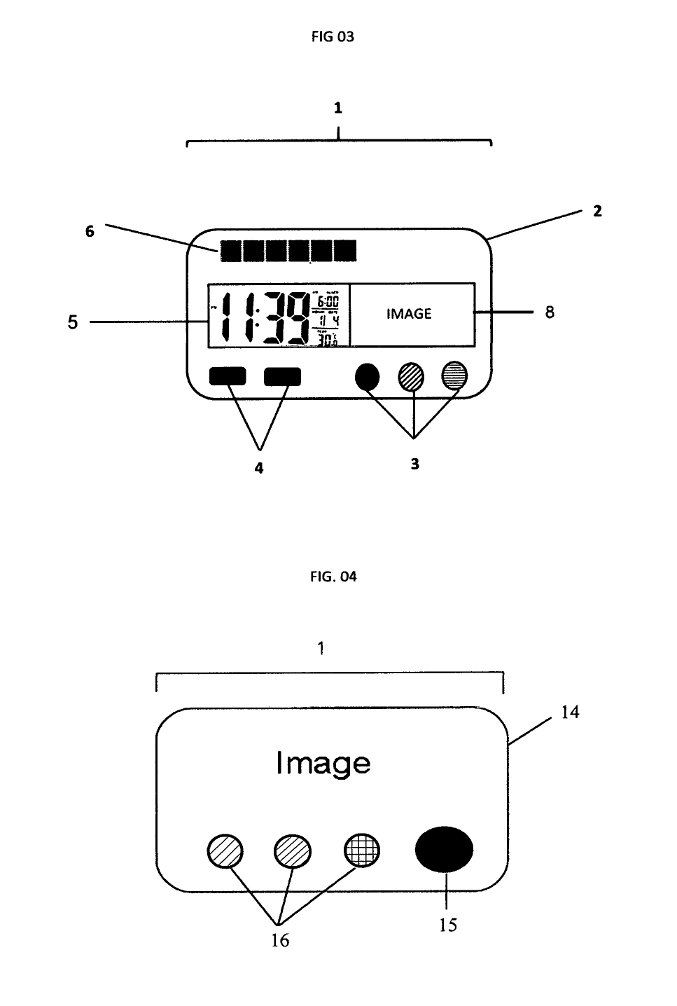

With reference to FIG. 03 illustrates another embodiment of the electronic reminder device 1. In this embodiment an extended LCD screen 8 stretches across the front face of the device and, in addition to the parameters shown in FIG. 01, provides space for display of image data. Image data may be in the form of logos, advertisements, photos or other messages.

With reference to FIG. 04 illustrates another embodiment of the electronic reminder device 1. In this embodiment the front face of device provides space for display of logo's, advertising, pictures or other messages and may be printed directly on the face of housing 2 or a stick on fascia 14 is used that incorporates a tactile dome button 15 and coloured lenses 16 that corresponds with the color of the required task

With reference to FIG. 05 illustrates the internal electronic components of the electronic reminder device 1, the internal components include:
3. LEDS, visible on external face of device with desired color coding.
4. Buttons, accessible on external face of device.
5. LCD screen,
6. Solar panel, visible on external face of the device
8. extra extended display
9. Battery, acting as back-up power source
10. MCU, micro-controller
11. PIR, passive infra-red sensor.
12. Blue-tooth receiver

With reference to FIG. 06 illustrates the internal electronic components of another embodiment of the electronic reminder device 1, the internal components include:
3. L.E.Ds, light emitting diodes visible through face of device with desired color coding
4. Button, accessible on external face of device
9. Battery, acting as power source
10. M.C.U, micro-controller
13. Xtal, crystal oscillator

### EXAMPLE

It is understood that the following example is not intended to limit the present invention but further aide the reader to understand the implementation of the invention.

An electronic reminder device 1 is provided with red, yellow and green LED lights 3 or lenses 16 on its front face and internal magnet for attachment to the household refrigerator. On receipt of the device the user, using control buttons 4 selects the preprogrammed sequence on which the red refuse bin, yellow refuse bin and green refuse bins are to be collected.

It is contemplated that the settings may be communicated to the device via means of a mobile phone or other mobile device application.

On the night before the red refuse bin is to be collected the red LED light flashes thus alerting the user to move the red refuse bin in a suitable location for collection by the municipal refuse collection vehicle.

More than one LED alert could go off on any week to suit local bin collection calendar.

After a set period of days the yellow LED flashes alerting the user to move the yellow refuse bin in a suitable location for collection by the municipal refuse collection vehicle.

After a set period of days the green LED flashes alerting the user to move the green refuse bin in a suitable location for collection by the municipal refuse collection vehicle.

The lights 3 will continue to flash for a set period, in a preferred embodiment this would be late morning the following day

The cycle continues until it is reset using the control buttons 4 on the device.

Preprogramming will be done at the manufacturers prior to being sent to user, settings for program will be to correlate with the bin collection calendar of the local municipal area to which it's being sent.

1. An electronic reminder apparatus comprising:
a housing having a customizable front panel,
a micro controller,
one or more light indicators of a chosen combination of colors,
one or more buttons to set a predetermined sequence of visual alerts and
a means for fastening the housing to another surface.

2. The reminder apparatus of claim 1 wherein said micro controller is programmed to provide reminders for collection of bins.

3. The reminder apparatus of claim 1 wherein the light indicators are color coded corresponding to the color of bin due for collection in a particular period of time.

4. The reminder apparatus of claim 1 wherein the programmable micro controller is programmed via mobile phone or mobile device app.

5. The reminder apparatus of claim 1 further comprises a printed plastic Fascia stuck on with a form of adhesive to front of housing.

6. The reminder apparatus of claim 1 wherein the housing is made from recycled materials.

7. The reminder apparatus of claim 1 further comprises an L.C.D screen with clock functions.

8. The reminder apparatus of claim 1 further comprises a P.I.R movement sensor to activate alerts or L.C.D screen function.

9. An electronic reminder apparatus comprising:
a housing having a customizable front panel,
a preprogrammed micro controller,
one or more light indicators,
one or more lenses of a chosen combination of color used to change the color or appearance of the light indicators,
one or more buttons to set a predetermined sequence of visual alerts and
a means for fastening the housing to another surface.

10. The reminder apparatus of claim 9 wherein said micro controller is preprogrammed to provide reminders for collection of bins.

11. The reminder apparatus of claim 9 wherein the light indicators are color coded corresponding to the color of bin due for collection in a particular period of time.

12. The reminder apparatus of claim 9 wherein the lenses are color coded corresponding to the color of bin due for collection in a particular period of time.

13. The reminder apparatus of claim 9 wherein the preprogrammed micro controller is reprogrammed via mobile phone or mobile device app.

14. The reminder apparatus of claim 9 further comprises a printed plastic Fascia stuck on with a form of adhesive to front of housing.

15. The reminder apparatus of claim 9 wherein the housing is made from recycled materials.

16. The reminder apparatus of claim 9 further comprises an L.C.D screen with clock functions.

17. The reminder apparatus of claim 9 further comprises a P.I.R movement sensor to activate alerts or L.C.D screen function.
